(19) United States
(12) Patent Application Publication
(10) Pub. No.: US 2015/0202755 A1
(43) Pub. Date: Jul. 23, 2015

(54) DRIVER

(71) Applicant: Isamu Tanji, Hitachinaka-shi (JP)

(72) Inventor: Isamu Tanji, Hitachinaka-shi (JP)

(73) Assignee: HITACHI KOKI CO., LTD., Tokyo (JP)

(21) Appl. No.: 14/419,899

(22) PCT Filed: Sep. 24, 2013
(86) PCT No.: PCT/JP2013/005610

§ 371 Date: Feb. 5, 2015

(30) Foreign Application Priority Data
Sep. 28, 2012 (JP) 2012-218310

(51) Int. Cl. B25C 1/04

(52) U.S. Cl. CPC B25C 1/047

(57) ABSTRACT

In a tubular guide part provided in a housing of a driver, a gas pressure accumulation member formed by filling compressed air in a bellows is provided. An actuating piston is detachably attached to a lower end surface of the gas pressure accumulation member. On a lateral surface of the actuating piston, latched parts and are provided so as to be arranged in a vertical direction. A driver blade is attached to an attachment part provided at a lower end surface of the actuating piston. When a cam is rotated to sequentially engage latching parts and with the latched parts and, the actuating piston is moved to the upper side. When the latching part is detached from the latched part, the actuating piston is moved downward by repulsive force of the compressed gas, and a nail is driven by the driver blade.

### TECHNICAL FIELD

The present invention relates to a driver for driving fasteners such as nails or staples into a driving object material.

### BACKGROUND ART

A driver for driving fasteners such as nails into a driving object material has a driver blade, which drives the fasteners through an injection port of the driver. The driver blade is attached to an actuating piston, which is reciprocatably incorporated in a driver body. When the actuating piston is actuated in a driving direction, the fastener is driven through the injection port by the driver blade.

In a driver described in Patent Literature 1, an actuating piston is actuated by the compressed air supplied from outside into a pressure accumulation chamber in the driver. When a trigger is operated to drive a fastener into a driving object material, the compressed air in the pressure accumulation chamber is supplied into a cylinder, and the actuating piston is actuated in the driving direction.

### CITATION LIST

### Patent Literature

PTL 1: Japanese Patent Application Laid-Open Publication No. 2008-149404

### SUMMARY OF INVENTION

### Technical Problem

In a type of driver, a gas pressure accumulation member is incorporated in a driver body, and compressed gas is filled in a pressure accumulation chamber in a gas pressure accumulation member. In this type of driver, when a trigger is operated, the gas pressure accumulation member is shrunk in an axial direction by an electric motor, and the gas pressure accumulation member is then expanded in the axial direction by the compressed gas in the shrunk pressure accumulation chamber. Thus, a driver blade is actuated by the gas pressure accumulation member.

In this type of driver, the driver blade enters the interior of the gas pressure accumulation member. Therefore, when the driver blade is worn and is to be replaced, the gas pressure accumulation member has also been required to be disassembled. Therefore, the conventional driver has a problem that maintenance thereof is cumbersome.

An object of the present invention is to make it possible to easily carry out the replacement of a driver blade in a driver having a gas pressure accumulation member.

### Solution to Problem

A driver of the present invention includes: a gas pressure accumulation member;

actuation mechanism which compresses the gas pressure accumulation member and then releases the compression; and a driver blade which is attached to the gas pressure accumulation member so as to be attachable/detachable from outside and strikes a fastener in conjunction with the release of the compression of the gas pressure accumulation member.

### Advantageous Effects of Invention

According to the present invention, the driver blade is attached to the gas pressure accumulation member so as to be attachable and detachable from outside. Therefore, the replacement of the driver blade or the actuating piston can be easily carried out.

### BRIEF DESCRIPTION OF DRAWINGS

FIG. 1 is a cross-sectional view of a driver of the first embodiment of the present invention.

FIG. 2 is a cross-sectional view showing the driver of FIG. 1 in a driving preparation state.

FIG. 3 is a cross-sectional view showing the driver of FIG. 1 in a driving operation.

FIG. 4 is an enlarged view of a trigger part of the driver of FIG. 1.

FIG. 5 is an enlarged view of the trigger part of the driver of FIG. 1.

FIG. 6 is an enlarged front view showing an injection port in a state in which a driver guide of the driver of FIG. 1 is removed.

FIG. 7A is a perspective view showing a cam of the driver of FIG. 1.

FIG. 7B is a perspective view showing a cam of the driver of FIG. 1.

FIG. 8 is a cross-sectional view showing a part of the driver of FIG. 1 in an enlarged manner.

FIG. 9 is a perspective view showing an outer appearance of an actuating piston of the driver of FIG. 1.

FIG. 10 is a cross-sectional view of a driver of the second embodiment of the present invention in a driving operation.

FIG. 11 is a cross-sectional view showing the driver of FIG. 10 in a driving preparation state.

FIG. 12 is an exploded perspective view showing a wind-up mechanism of the driver of FIG. 10.

FIG. 13 is a perspective view showing a motion of the wind-up mechanism of FIG. 12.

FIG. 14 is a perspective view showing a motion of the wind-up mechanism of FIG. 12.

FIG. 15 is a perspective view showing a motion of the wind-up mechanism of FIG. 12.

FIG. 16 is a drawing showing a rotation position detecting device of a drum.

FIG. 17 is a cross-sectional view of a driver of the third embodiment of the present invention in a driving operation.

FIG. 18 is a cross-sectional view showing the driver of FIG. 17 in a driving preparation state.

FIG. 19 is a cross-sectional view showing a part of the driver of FIG. 17 in an enlarged manner.

FIG. 20 is a cross-sectional view showing a part of a driver which is a modification example of the third embodiment of the present invention, and it shows a part similar to that of FIG. 19.

### DESCRIPTION OF EMBODIMENTS

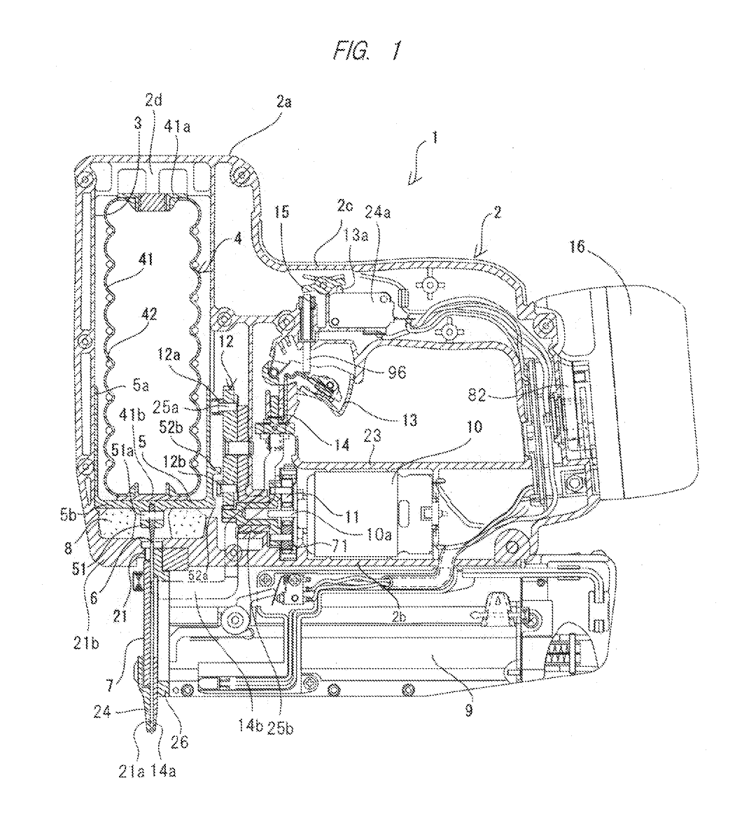

Hereinafter, a driver according to an embodiment of the present invention will be described with reference to FIG. 1 to FIG. 4. The driver 1 shown in FIG. 1 to FIG. 3 is an electric tool and is used for driving fasteners 102 such as staples or nails into a driving object material 36 such as a timber or a gypsum board. The driver 1 has a housing 2 which constitutes a driver body, and the housing 2 has a main body 2a and a grip 2c which forms an approximately right angle to a vertical direction and projects from an upper part of the main body 2a toward the rear. With respect to the housing 2, the direction in which the grip 2c projects is defined as the rear, and the opposite side thereof is defined as the front. A motor 10, a deceleration mechanism 11 made up of a planetary gear mechanism, a cam 12 serving as a compression mechanism, a hollow actuating piston 5, and a gas pressure accumulation member 4 are incorporated in the housing 2. A magazine 9 is mounted on a bottom wall 2b of the housing 2, and the fasteners 102 are housed in the magazine 9.

The actuating piston 5 has a cylindrical part 5a and an end wall part 5b which is integrated with a lower end part thereof, and is housed in the main body 2a so as to be reciprocatable in the vertical direction in FIG. 1 to FIG. 3. The direction of moving the actuating piston 5 backward to the upper side is defined as a pushing-up direction of the actuating piston 5, and the direction of moving the piston forward to the lower side from a backward limit position is defined as a driving direction of the actuating piston 5. A mechanism which pushes up the actuating piston 5 has a cam 12 disposed along the vertical direction which is the moving direction of the actuating piston 5. A rotating shaft 10a of the motor 10 is coupled to the deceleration mechanism 11, and the cam 12 is coupled to an output shaft of the deceleration mechanism 11. The actuating piston 5 is moved backward by the cam 12 actuated by the motor 10, and is moved forward from the backward limit position by the gas pressure accumulation member 4. The movement of the actuating piston 5 in the forward direction is defined as a downward direction.

Air is exemplified as the gas which is filled and contained in the inside of the gas pressure accumulation member 4. However, the gas is not limited to air. For example, nitrogen gas or carbon dioxide gas can also be used.

The housing 2 is made of resin such as nylon or polycarbonate. The cam 12 and the gas pressure accumulation member 4 are mainly incorporated in the main body 2a of the housing 2. A sub body 23 is mounted on the grip 2c of the housing 2, and the motor 10 and the deceleration mechanism 11 are mainly incorporated in the sub body 23.

A flat-plate-like blade guide 26 which guides a driver blade 6 is provided at a lowermost end part of the main body 2a. A driver guide 7 is disposed to be opposed to a front surface of the blade guide 26, and the driver guide 7 projects to the lower side of the main body 2a. An injection port 21a is formed between the driver guide 7 and the blade guide 26. This injection port 21a penetrates through the main body 2a and communicates with the bottom wall of the actuating piston 5. On the upper side of the blade guide 26, a cover plate (not shown) which is positioned at a front surface of the later-described driver blade 6 is disposed. In a lower part of the main body 2a, a receiving part 21b which receives the press-down force of the actuating piston 5 is provided.

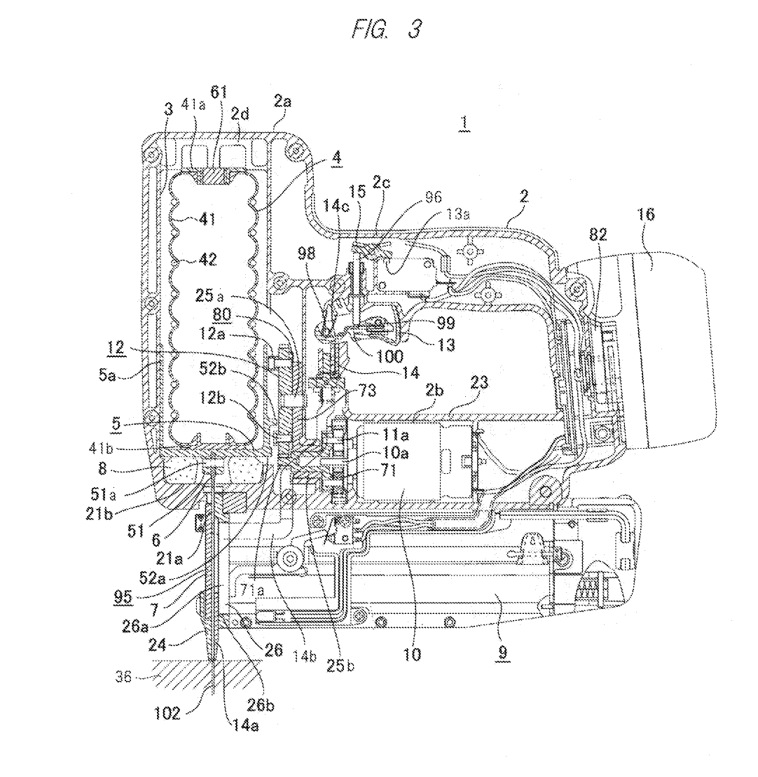

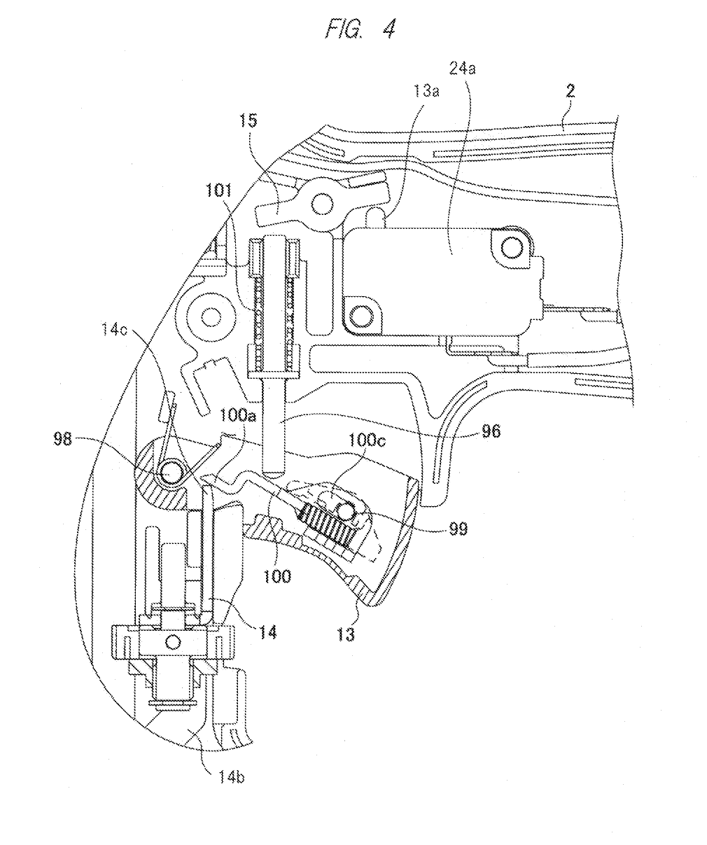

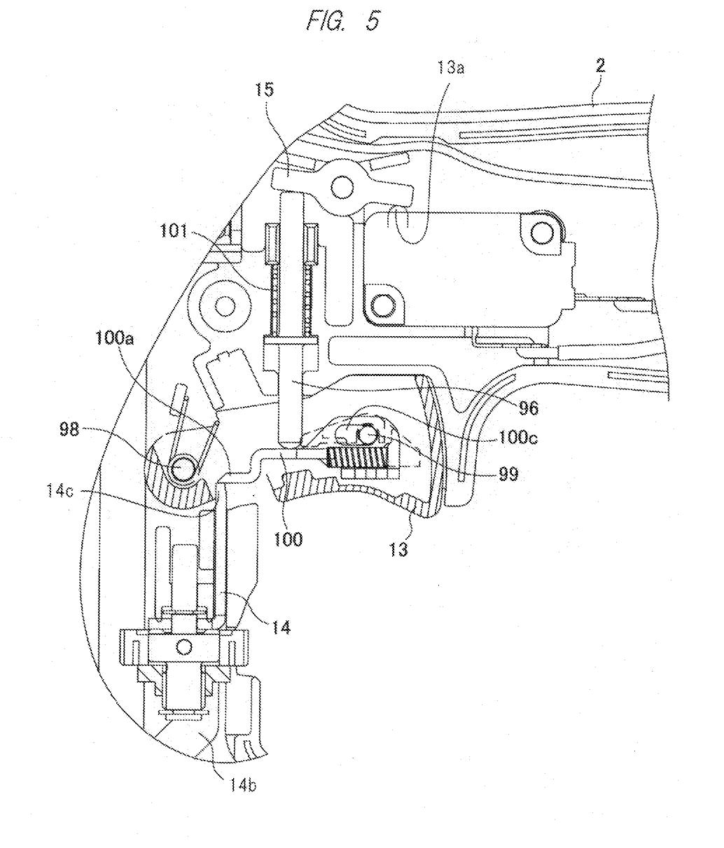

As shown in FIG. 3, a trigger 13 for a driving operation of the driver is provided in the grip 2c of the housing 2. The trigger 13 is pulled by a finger of a hand which holds the outer periphery of the grip 2c, and when the trigger 13 is operated, the motor 10 is actuated. As shown in FIG. 4 and FIG. 5, a starting switch 13a which is operated by the trigger 13, a switch plunger 96, and a switch lever 15 are provided in the grip 2c. The switch plunger 96 activates the starting switch 13a via the switch lever 15.

A detachable battery 16 is mounted at a rear end of the grip 2c. A power-supply control unit 82 is provided in the grip 2c. The power-supply control unit 82 controls the electric power which is supplied from the battery 16 to the motor 10 based on detection results from the starting switch 13a, and others.

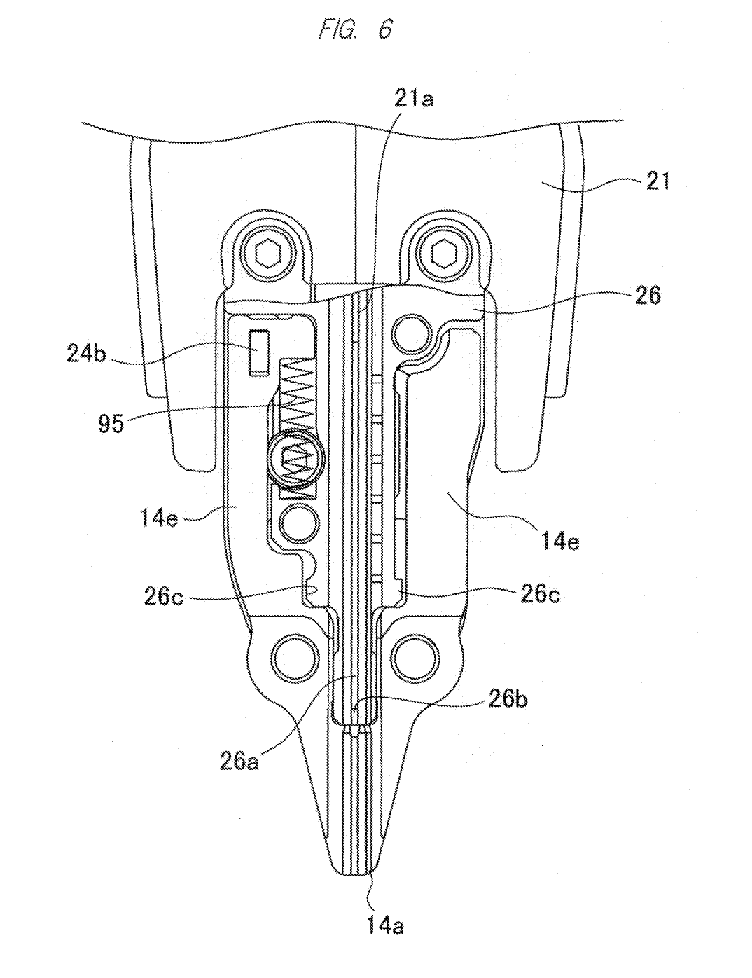

A push lever 14 is mounted in the housing 2 so as to be vertically movable with respect to the main body 2a. The push lever 14 has a distal end part, in other words, a lower end part 14a projecting from a lower end part of the injection port 21a and an upper end part 14c positioned in the vicinity of the trigger 13, and the part between the lower end part 14a and the upper end part 14c serves as a bent arm part 14b. A nose 24 is attached to a front surface of the driver 7 so as to be opposed to the lower end part 14a of the push lever 14. The part between the nose 24 and the lower end part 14a serves as a part of the injection port 21a. As shown in FIG. 6, a spring 95 is provided between the push lever 14 and the blade guide 26, and spring force toward the upper side is applied to the push lever 14 by the spring 95.

As shown in FIG. 3, the distal end part 14a of the push lever 14 forms a part of the injection port 21a, which is a driving port at the head of a feed passage through which the fasteners are supplied from the magazine 9. The distal end part 14a is guided by the blade guide 26 which constitutes the injection port 21a and is reciprocatably supported by the blade guide 26. When the nose 24 is made to abut on the driving object material 36, the push lever 14 is prevented from being moved to the rear of the distal end of the driver guide 7 or from being moved and projected to the lower side of the nose 24.

As shown in FIG. 4 and FIG. 5, the trigger 13 is mounted on the main body 2a so as to be turnable about a turning shaft 98 serving as a fulcrum point. The trigger 13 is provided with a trigger arm 100 in which a long hole 100c is formed. A pin 99 provided on the trigger 13 is inserted in the long hole 100c. The switch plunger 96 is mounted on the grip 2c so as to be movable in the vertical direction, and the spring force in the direction toward the trigger arm 100 is applied to the switch plunger 96 by a spring 101. When the trigger 13 is pulled, a free end part 100a of the trigger arm 100 is engaged with the upper end part 14c of the push lever 14, and an approximately center part of the trigger arm 100 is engaged with the distal end of the switch plunger 96. When the trigger 13 is returned, the engagement between the free end part 100a of the trigger arm 100 and the upper end part 14c is released.

When the trigger 13 is pulled in the state in which the push lever 14 and the free end part 100a are engaged, the switch plunger 96 presses the starting switch 13a, which is provided in the grip 2c, via the switch lever 15 and sets it to an ON state, and as a result of this ON state, the motor 10 connected to the battery 16 is activated. In this manner, when the switch plunger 96 is at a downward limit position, the driver maintains an OFF state. On the other hand, when the switch plunger 96 is moved upward against a drag of the spring 101, the switch lever 15 is turned to set the starting switch 13a to an ON state, so that the motor 10 is activated and the driving operation by the driver is started.

The deceleration mechanism 11 which is positioned in the rear of the gas pressure accumulation member 4 and is made up of a planetary gear mechanism 71, a final gear 72 which is actuated by the deceleration mechanism 11, and a gear holder 73 which retains the final gear 72 are disposed in the main body 2a. The gear holder 73 is provided with a supporting shaft 25a which rotatably supports the final gear 72. The supporting shaft 25a projects from the gear holder 73 to the front side. In the gear holder 73, a through hole 25b is formed to be positioned on the lower side of the supporting shaft 25a. The output shaft of the deceleration mechanism 11 penetrates through the through hole 25b, and the output shaft is provided with an output gear 71a which is meshed with the final gear 72.

On the lower side of the sub body 23, the magazine 9 is disposed so as to extend in the front-rear direction. In the magazine 9, a supply port is formed so as to communicate from a distal end thereof to the injection port 21a of the driver guide 7 via the blade guide 26. The fasteners 102 in the magazine 9 are supplied to the supply port. In the magazine 9, a pusher (not shown) which pushes the fasteners 102 toward the supply port is provided. The magazine 9 is disposed on the lower side of the sub body 23 so that the direction in which the pusher pushes the fasteners 102 is parallel to the front-rear direction. In the magazine 9, the plurality of fasteners 102 mutually coupled in an aligned manner are retained, and a front-side end part of the magazine 9 is opposed to the rear side of the blade guide 26 in the injection port 21a. Thus, the fasteners 102 are supplied to a position on the rear side of the blade guide 26 in the injection port 21a. The pusher is slidably mounted in the magazine 9, is biased by a spring (not shown) toward the blade guide 26 side in the front, and is disposed in the rear of the fasteners 102. Accordingly, the top of the fasteners 102 is sequentially supplied into the injection port 21a by the pusher.

As shown in FIG. 3, the blade guide 26 is provided with a feed passage 26a through which the fasteners 102 in the magazine 9 pass. As shown in FIG. 6, a tip receiving part 26b which supports tip ends of the fasteners 102 is formed on the lower side of the feed passage 26a. A guiding projection part 26c which extends in parallel to the feed passage 26a is provided so as to project on the front surface of the blade guide 26.

The push lever 14 is always pressed toward the top dead center by the spring 95 provided between the push lever 14 and the blade guide 26. The spring force of the spring 95 is set to be smaller than the spring force of the plunger spring 101 which presses the switch plunger 96 toward the lower side.

The feed passage 26a on the front surface of the blade guide 26 shown in FIG. 6 and a guiding part 14e of the push lever 14 are covered by the driver guide 7 shown in FIG. 3. The driver guide 7 is fixed to the blade guide 26 by a screw. Therefore, the push lever 14 is guided so as to be vertically slidable between the driver guide 7 and the blade guide 26.

The driver guide 7 is provided on a front surface of the feed passage 26a. Since the pressing force from the spring (not shown) applied to the pusher via the fasteners 102 is applied to the driver guide 7, this pressing force does not act on the push lever 14. Therefore, the pressing force of the spring 95 which pushes up the push lever 14 can be set to be small regardless of the pressing force of the pusher.

The distal end part 14a of the push lever 14 has a guide surface for the vertical movement of the driver blade 6. More specifically, the distal end part 14a of the push lever 14 is fixed by a screw so as to form the injection port 21a together with the approximately flat-plate-like nose 24 which covers a part of the distal end part 14a. The nose 24 and the push lever 14 are integrated with each other so as to be slidable in the vertical direction. Also, as shown in FIG. 6, the distal end part 14a of the push lever 14 has a tapered shape which becomes gradually thinner as it gets closer to the lower side.

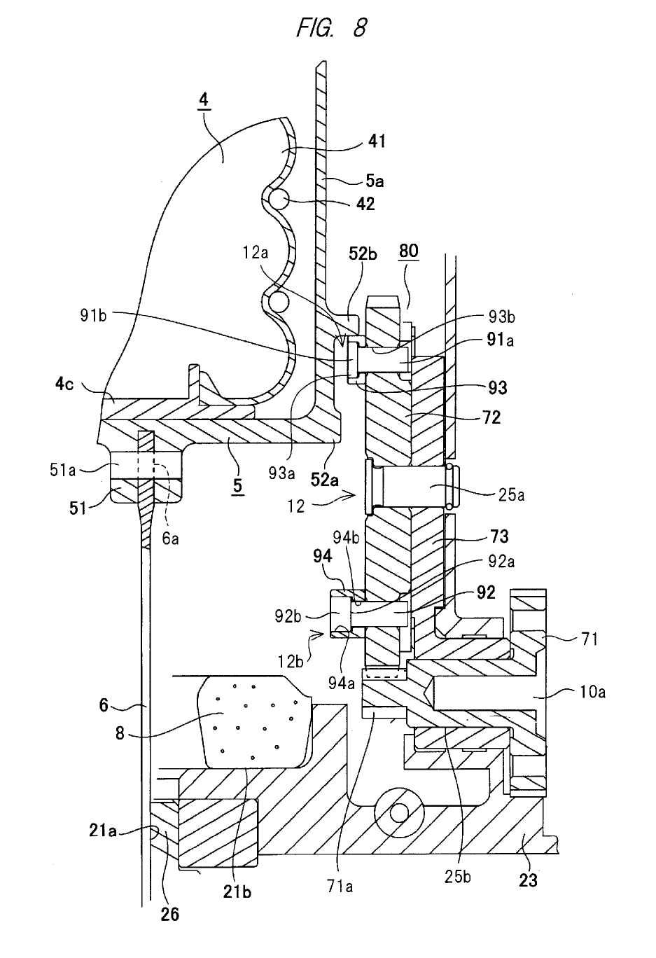

The deceleration mechanism 11 has the planetary gear mechanism 71, which is coupled to the rotating shaft 10a of the motor 10, and the final gear 72. The planetary gear mechanism 71 is a publicly known gear mechanism having a sun gear attached to the rotating shaft 10a, a planetary gear meshed therewith, a carrier which supports the planetary gear, and others. As shown in FIG. 8, the output gear 71a provided at the output shaft of the planetary gear mechanism 71 is meshed with the final gear 72 which is rotatably supported by the supporting shaft 25a.

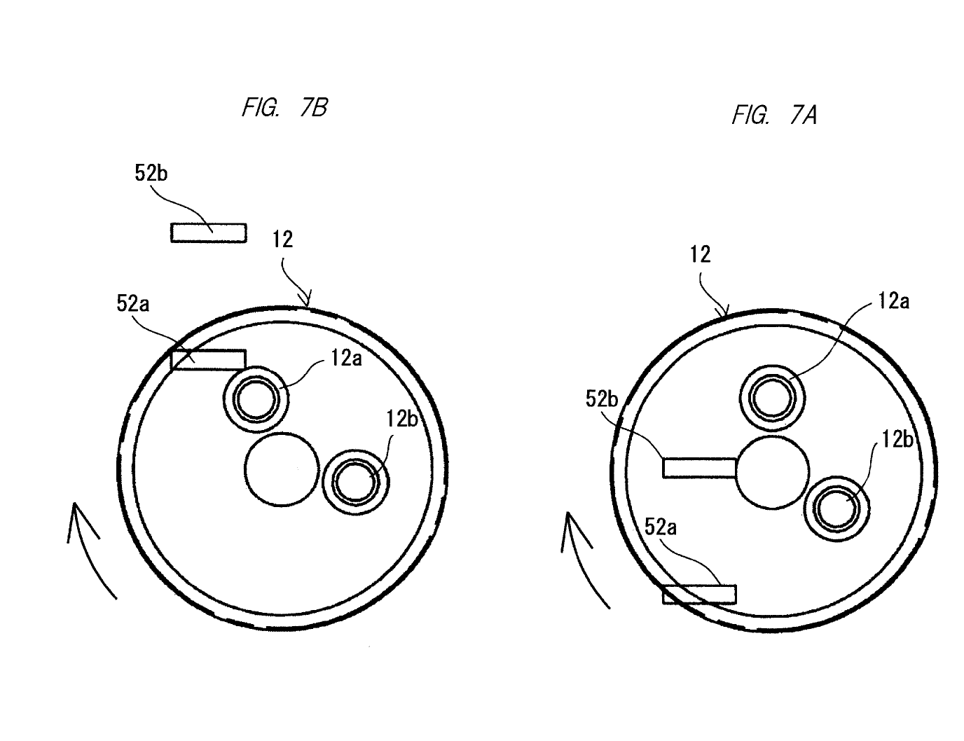

The final gear 72 which is a rotor constitutes the cam 12, and a first latching part 12a and a second latching part 12b which are provided to project toward the actuating piston 5 are provided on a front surface of the final gear 72. As shown in FIG. 7, the first latching part 12a and the second latching part 12b are disposed at equal radial positions from the shaft center of the supporting shaft 25a at an interval of about 120 degrees in the circumferential direction.

As shown in FIG. 8, the first latching part 12a is made up of a pin 91 which is fixed to the final gear 72 and projects toward the front side and a roller 93 which is rotatably mounted thereon. Similarly, the second latching part 12b is made up of a pin 92 which is fixed to the final gear 72 and projects toward the front side and a roller 94 which is rotatably mounted thereon. Both of the pins 91 and 92 have the same diameter, but the projecting length of the pin 92 is longer than the projecting length of the pin 91. Each of the rollers 93 and 94 is engaged with the actuating piston 5.

The first pin 91 has an approximately-cylindrical first base part 91a which projects from the front surface of the final gear 72 and a flange part 91b which is disposed at a front end part of the first base part 91a and has a larger diameter than that of the first base part 91a. For the reasons in terms of processing that it is not easy to process the boundary part between the first base part 91a and the first flange part 91b into an orthogonal shape, an annular groove is formed in the circumferential direction of the first base part 91a. In a first roller 93, a first through hole 93a which is rotatably mated with the first flange part 91b and a second through hole 93b which has a smaller diameter than that of the first through hole 93a are coaxially formed. Since the outer diameter of the first flange part 91b is larger than the diameter of the through hole 93b, the first roller 93 is prevented from falling from the first pin 91. In the first roller 93, the depth of the through hole 93a in the axial direction is designed to be approximately the same as the length of the first flange part 91b in the front-rear direction. Therefore, the front ends of the first flange part 91b and the first roller 93 are disposed on the same plane.

Like the first pin 91, the second pin 92 also has a second base part 92a and a second flange part 92b. Also in the second roller 94, a first through hole 94a and a second through hole 94b which has a smaller diameter than that of the first through hole 94a are coaxially formed like the first roller 93. Since the second latching part 12b projects more than the first latching part 12a, the second flange part 92b has a larger distance in the front-rear direction compared with the first flange part 91b. In accordance with this, the first through hole 94a of the second roller 94 is formed to have a larger axial-direction depth than that of the first through hole 93a of the first roller 93. As a result, the contact area between the second roller 94 and the second flange part 92b is larger than the contact area between the first roller 93 and the first flange part 91b.

In the housing 2, a tubular guide part 3 is provided, and the gas pressure accumulation member 4 provided in the tubular guide part 3 is made up of an accordion-like bellows 41. Compressed air is contained in the bellows 41. The bellows 41 is formed of a flexible material such as fiber-reinforced rubber and is configured to have air tightness by, for example, a metal thin film. The upper and lower ends of the bellows 41 are sealed with a sealing member 41a and a sealing member 41b whose end surfaces are flat surfaces. The bellows 41 forms a hollow tubular shape and is expansible/shrinkable straight in the vertical direction. Intermediate rings 42 are provided at several locations at small-diameter parts of the bellows 41, several bulges are provided like a Japanese lantern between the intermediate rings 42 and the bellows 41, and the sealing member 41a and the sealing member 41b are provided at both ends of the bellows 41 so as to seal it to maintain air tightness. The intermediate rings 42 between the swellings are mated in order to receive the tensile force caused by the internal pressure and maintain the outer diameters of the small-diameter parts. The thickness of the rubber film of the bellows 41 is normally about 2 to 4 mm. The bellows 41 has an inner-surface rubber layer for maintaining air tightness, a cord-reinforced layer for supporting the tensile force caused by the internal pressure, and an outer-surface rubber layer for protecting the main body from the influence of the external environment. Normally, ring-like steel-made bead wires are embedded in the attachment parts to the sealing member 41a and the sealing member 41b at the both ends of the bellows 41.

The actuating piston 5 is detachably attached to the lower end surface of the gas pressure accumulation member 4, and the upper end thereof is received by a receiving part 2d in the housing 2. The gas pressure accumulation member 4 has a gas filling port 61 at an upper end part thereof, and gas can be refilled therein.

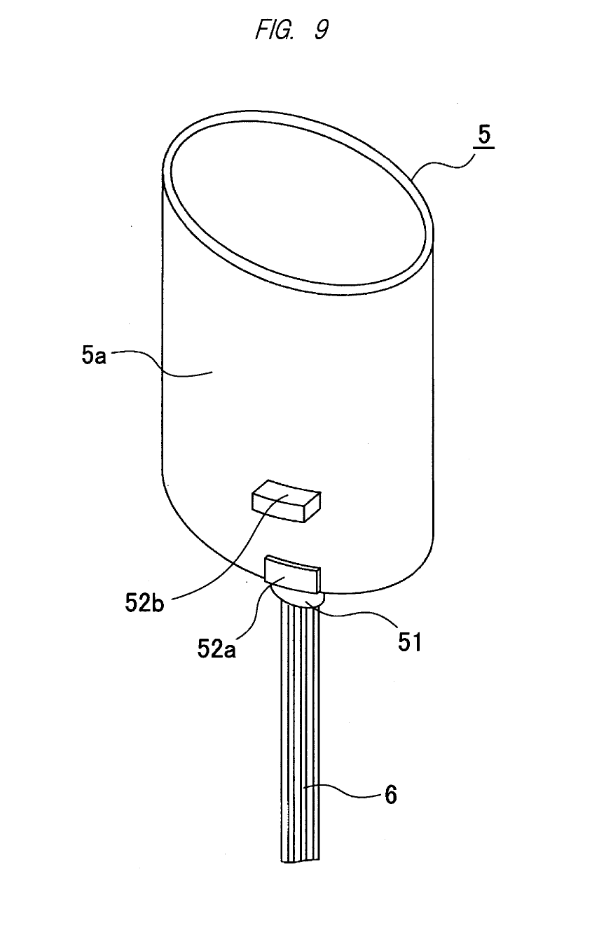

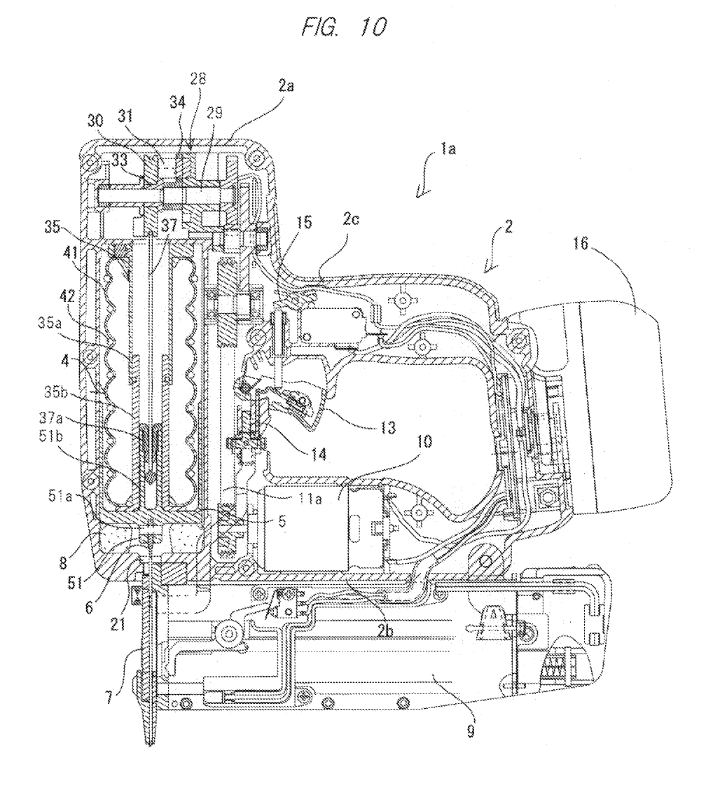

The actuating piston 5 has a bottomed tubular shape with an approximately U-shape cross section, and as shown in FIG. 9, the driver blade 6 for driving nails is attached to an attachment part 51 provided to project toward the lower side. Since the driver blade 6 is guided by the injection port 21a formed by the driver guide 7, the blade guide 26, and the nose 24, the vertical movement of the actuating piston 5 is guided by the driver blade 6. The actuating piston 5 is always biased downward by the gas pressure accumulation member 4. The end wall part 5b is detachably fixed to the gas pressure accumulation member 4 so as to cover the lower end part of the gas pressure accumulation member 4. More specifically, the actuating piston 5 is attached to the gas pressure accumulation member 4 so as to be attachable/detachable from outside. On a lateral surface of the actuating piston 5, latched parts 52a and 52b are provided to be arranged in the vertical direction. The attachment part 51 is provided on the lower end surface of the actuating piston 5 so as to project therefrom. Also, the cylindrical part 5a extending like a tube toward the upper side is in slidable contact with the tubular guide part 3 of the housing 2 and prevents the actuating piston 5 from being tilted with respect to the housing 2 when sliding vertically. Though not shown in the drawings, it is also possible to improve slidability and wear resistance by providing a tubular thin steel plate between the tubular guide part 3 and the cylindrical part 5a. Since the gas pressure accumulation member 4 is disposed inside the tubular actuating piston 5 in this manner, the gas pressure accumulation member 4 can be protected. Specifically, since the cylindrical part 5a prevents the bellows 41 from sticking out to the outer side, the bellows 41 is prevented from abutting on the first latching part 12a and the second latching part 12b. As is understood from FIG. 1 to FIG. 3, the upper end of the cylindrical part 5a of the actuating piston 5 in which the gas pressure accumulation member 4 is disposed has a tapered shape, which is tilted so that the inner diameter thereof is gradually reduced as it gets closer to the lower side. By virtue of this shape, it is possible to prevent the cylindrical part 5a from being caught by the bellows 41 when the gas pressure accumulation member 4 shrinks, and the effect of preventing damage of the bellows 41 is enhanced.

The latched part 52a projects from an upper-side position of the actuating piston 5 toward the rear side so as to have a projecting distance with which it can be engaged with the latching part 12a. The latched part 52b projects from a lower end position of the actuating piston 5 toward the rear side so as to have a projecting distance with which it cannot be engaged with the latching part 12a but can be engaged with the latching part 12b. The driver blade 6 is detachably mounted on the attachment part 51.

As shown in FIG. 8, the driver blade 6 is formed to have a thin-plate like shape, a through hole 6a is formed in an upper end part thereof, and a pin 51a is mated in a through hole which is formed in the attachment part 51 so as to correspond to the through hole 6a. The driver blade 6 is detachably attached to the attachment part 51 by the pin 51a. As shown in FIG. 3, the driver blade 6 is disposed in the injection port 21a so as to be vertically movable. The driver blade 6 reaches the interior of a guide hole of the driver guide 7, which projects from the lower end surface of the housing 2, through an insertion hole 21 formed in the lower end surface of the main body 2a. Note that the driver blade 6 can be made to be independently replaceable also when an attachment part is provided at the sealing member 41b to attach the driver blade 6 to the bellows 41.

A piston bumper 8 serving as a buffer for reducing shock in the downward movement of the actuating piston 5 is housed in a lower end part in the housing 2. The piston bumper 8 is made of soft rubber or resin such as urethane, is disposed below the actuating piston 5, and is configured to be able to abut on the lower end surface of the actuating piston 5. The magazine 9 is attached to a right lateral surface of the driver guide 7.

Next, the operation of the driver 1 will be described.

In the state shown in FIG. 1, the distal end part 14a of the push lever 14 and the nose 24 are caused to lightly abut on the front surface of the driving object material 36. The injection port 21a is formed between the distal end part 14a and the nose 24. When the trigger 13 is pulled to start the driver, as shown in FIG. 4, the trigger 13 turns about the turning shaft 98 toward the switch plunger 96. As a result, the pin 99 of the trigger arm 100 is moved to the upper side, so that the center part of the trigger arm 100 abuts on the distal end part of the switch plunger 96.

As a result, as shown in FIG. 4, the distal end part of the switch plunger 96 serves as a fulcrum point, the pin 99 serves as a point of effort, and the free end part 100a of the trigger arm 100 tries to push down the distal end part 14c of the push lever 14. However, since the distal end part 14a of the push lever 14 abuts on the surface of the driving object material 36, downward movement of the push lever 14 is prevented, and the switch plunger 96 cannot push down the push lever 14. Since the push lever 14 is not moved because the downward movement is prevented, in conjunction with the pulling operation of the trigger 13, the distal end part of the switch plunger 96 serve as the point of effort, the pin 99 serves as the point of fulcrum, and the switch plunger 96 is pushed up by the center part of the trigger arm 100. As a result, the switch lever 15 is turned to set the starting switch 13a to an ON state, so that electric power is supplied to the motor 10 and the motor 10 is started.

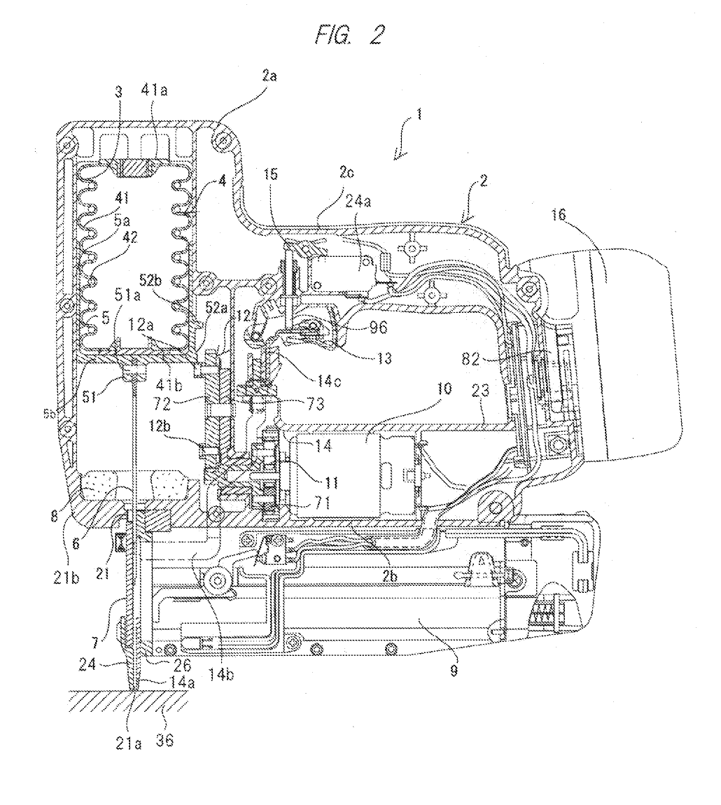

When the cam 12, that is, the final gear 72 is rotated by the motor 10, the latching part 12a is engaged with the lower surface of the latched part 52a before the latching part 12b reaches the top dead center. In this state, by the continued rotation of the final gear 72, the actuating piston 5 is moved toward the upper side. When the latching part 12b has passed the top dead center and is detached from the latched part 52b, the actuating piston 5 is further moved up in conjunction with the upward displacement of the latching part 12a. When the latching part 12a reaches the top dead center, as shown in FIG. 2, the actuating piston 5 reaches the top dead center. After the actuating piston 5 has reached the top dead center, when the cam 12 is further rotated and the latching part 12a is detached from the lower surface of the latched part 52a, the actuating piston 5 comes into a state where it can be moved toward the lower side.

The upward movement of the actuating piston 5 by the rotation of the cam 12 is carried out against the gas pressure of the compressed gas in the gas pressure accumulation member 4, and the air in the gas pressure accumulation member 4 is compressed and energy is accumulated in conjunction with the upward movement of the actuating piston 5. Therefore, when the latching part 12a is detached from the latched part 52a, as shown in FIG. 3, the actuating piston 5 is biased and moved downward by the repulsive force of the compressed air, and in conjunction with this, the nail is driven through the injection port 21a at the top of the feed passage 26a into the driving object material 36 by the driver blade 6.

When the fastener 102 is driven into the driving object material by the driver blade 6, the driver 1 is moved in the direction opposite to the driving object material 36 by the reactive force of the driving. The plunger spring 101 is always pressing the switch plunger 96 downward with respect to the free end part 100a of the trigger arm 100. Since the load thereof is set to be larger than the load of the spring 95 which is pushing up the push lever 14 to the top dead center, the contact point of the switch plunger 96 with the trigger arm 100 serves as the point of effort. Also, the pin 99 serves as the point of fulcrum, and the free end part 100a of the trigger arm 100 pushes down the upper end part 14c of the push lever 14. As a result, the driver 1 is moved in a direction away from the surface of the driving object material 36, but the distal end part 14a of the push lever 14 is moved toward the relatively lower side with respect to the driver 1 so as to keep abutting on the surface of the driving object material 36. In this manner, until the fastener 102 is completely driven into the driving object material 36, a head part of the fastener 102 is reliably guided by the injection port formed by the distal end part 14a of the push lever 14 and the nose 24.

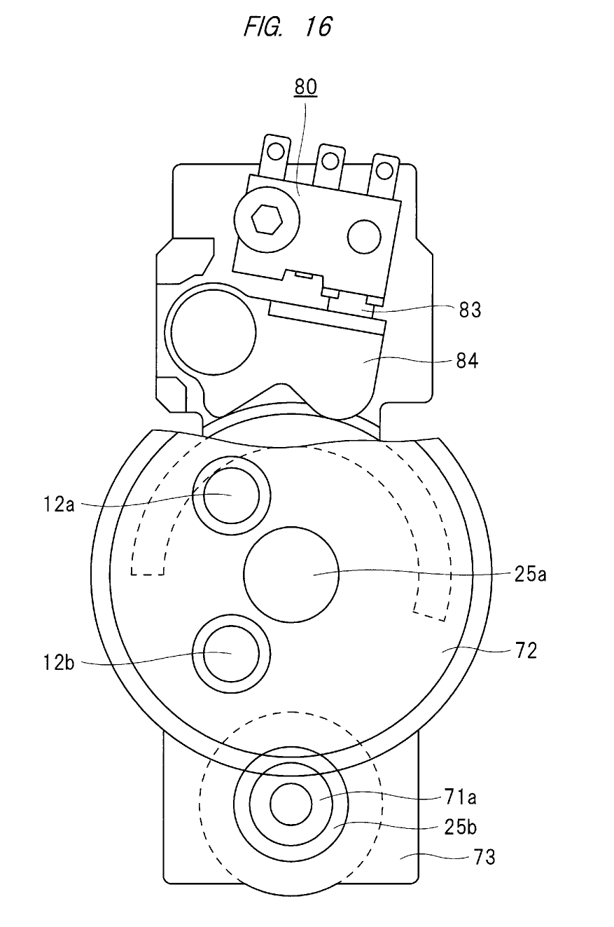

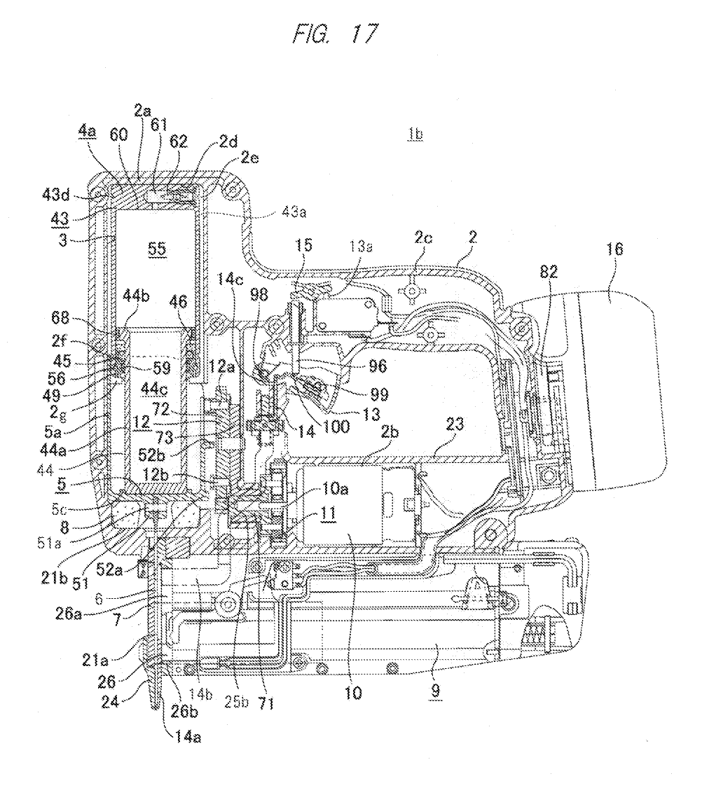

The timing at which the latching part 12a is detached from the latched part 52a and the timing at which the latching part 12b is engaged with the latched part 52b are adjusted by the power-supply control unit 82 so that the actuating piston 5 is returned after the actuating piston 5 has collided with the piston bumper 8 and stopped. In this adjustment, the rotation state of the final gear 72 is set by a detection signal from a microswitch 83 shown in FIG. 16 based on abutting of the microswitch 83 by a switch lever 84.

According to the present embodiment, the actuating piston 5 is fixed to the gas pressure accumulation member 4 so as to be attachable/detachable from the outside, and the driver blade 6 is fixed to the actuating piston 5. Therefore, the driver blade 6 can be replaced by replacing the actuating piston 5 without disassembling the gas pressure accumulation member 4. Accordingly, the replacement of the driver blade 6 can be easily carried out. Moreover, according to the present embodiment, when the latched part 52b is moved upward by the latching part 12b and the latched part 52a is moved upward by the latching part 12a in conjunction with approximately one rotation of the cam 12, the actuating piston 5 is moved upward. Therefore, the stroke of the actuating piston 5 can be enlarged even with the cam 12 having a comparatively small diameter.

Also, since the gas pressure accumulation member 4 is separately provided from the actuating piston 5 and the driver blade 6, compression of the gas pressure accumulation member 4 can be achieved with the comparatively simple cam structure, and the driver can be manufactured at low cost. Since there is no piston sliding part in the gas pressure accumulation member 4, wear of a sealing part of the sliding part does not occur. Further, since gas leakage from the sliding part in the compression of the gas pressure accumulation member 4 is less likely to occur, the reduction in the pressure due to the gas leakage of the gas pressure accumulation member 4 caused by repeated operation can be prevented, and thus, energy drop can be prevented. Moreover, since the expanding/shrinking accordion part whose strength is comparatively low is not directly compressed by the actuating piston 5, durability of the gas pressure accumulation member 4 can be improved.

The embodiment adopts the structure in which the gas pressure accumulation member 4 is compressed by moving the actuating piston 5, but it is also possible to adopt the structure in which the gas pressure accumulation member is compressed by actuating the driver blade to move the actuating piston 5 itself instead of just moving the actuating piston 5.

Next, the second embodiment of the present invention will be described.

In the driver 1 of the first embodiment, the power of the motor 10 is transmitted to the actuating piston 5 by using the deceleration mechanism 11 and the cam 12. However, in a driver 1a of the present embodiment shown in FIG. 10 to FIG. 16, a pressure accumulation piston 44 is linearly reciprocated by a belt mechanism 11a and a wind-up mechanism 28, thereby transmitting the power of the motor 10 to the actuating piston 5.

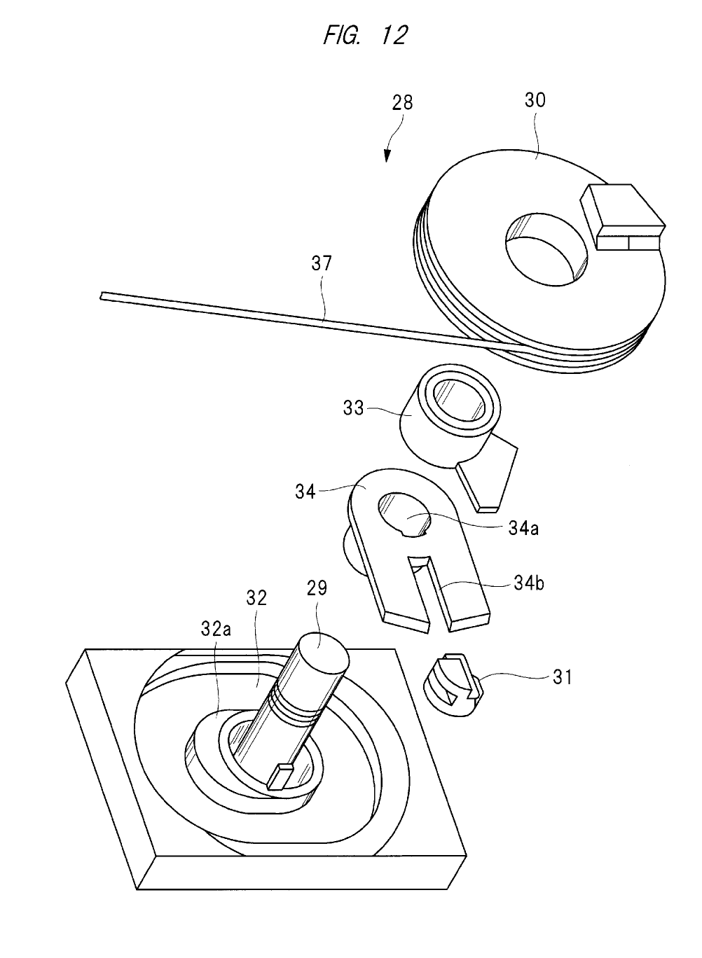

As shown in FIG. 12, the wind-up mechanism 28 is made up of: a wind-up body 30 which winds up a wire 37; a rotating shaft 29 to which power is output from the belt mechanism 11a; a rotary pressing body 34 which is fixed to the rotating shaft 29; a rotor 33 which is rotatably attached to the rotating shaft 29; and a movable body 31 which is pressed by the rotary pressing body 34 and moved in a passage 32. The wind-up body 30 is mated and fixed to the rotor 33. A hole 34a is formed in the rotary pressing body 34, and the rotating shaft 29 is inserted in the hole 34a. A groove forming part extends from the rotary pressing body 34 in a direction approximately orthogonal to the penetrating direction of the hole 34a, and a slit 34b extending in the direction approximately orthogonal to the penetrating direction of the hole 34a is formed in the groove forming part. The movable body 31 is slidably disposed in the slit 34b. The passage 32 is formed to have an oblong circular shape provided with a large-diameter part 32a around the rotating shaft 29. The movable body 31 is moved in a radial direction in the slit 34b in accordance with the circumferential position of the rotary pressing body 34 so as to move toward and away from the rotating shaft 29.

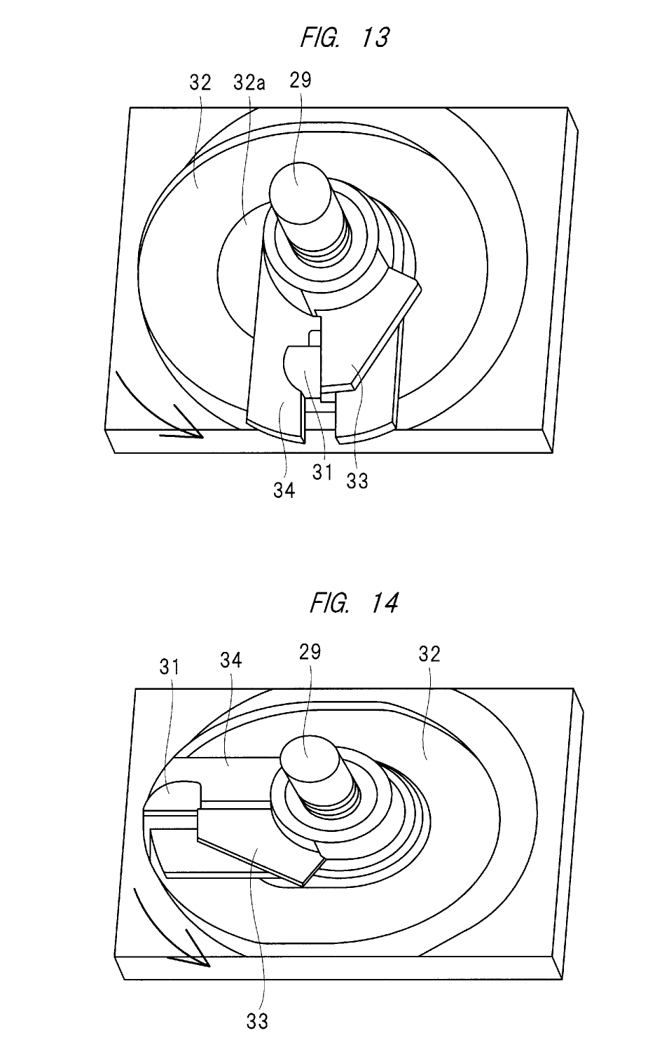

When the rotating shaft 29 is rotated in the direction of an arrow from a state in which the movable body 31 and the rotor 33 are at a bottom dead center as shown in FIG. 13, the rotary pressing body 34 is integrated and rotated with the rotating shaft 29, and the movable body 31 is pressed by the rotary pressing body 34 and is moved in the rotating direction of the rotating shaft 29 in the passage 32. The rotor 33 is pressed by the movable body 31 and rotated in the same direction together with the wind-up body 30. In this manner, the wire 37 is wound up by the wind-up body 30.

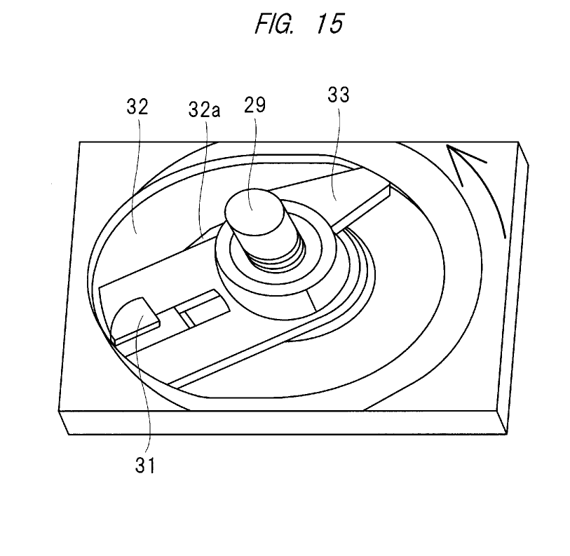

As shown in FIG. 14, when the movable body 31 is rotated to the large-diameter part 32a provided in the passage 32, the engagement between the movable body 31 and the rotor 33 is released, and the movable body 31 and the rotary pressing body 34 continue to rotate. Thus, the pressing from the movable body 31 to the rotor 33 is released, and as shown in FIG. 15, the rotor 33 can be moved together with the wind-up body 30 in the opposite direction in the passage 32. As a result, a state in which the wire 37 is fed from the wind-up body 30 is obtained. This motion is repeated every time the rotating shaft 29 rotates one time.

An inner piston 35 is made up of a sleeve 35a which is fixed to an upper end part in the housing 2 and a cylindrical sliding part 35b which is housed in the sleeve 35a so as to be vertically slidable. The inner piston 35 penetrates through the interior of the gas pressure accumulation member 4 in the vertical direction, and a distal end of the sliding part 35b is detachably fixed to the actuating piston 5. In other words, the actuating piston 5 is attached to the gas pressure accumulation member 4 so as to be attachable/detachable from the outside. A distal end part of the wire 37 is fixed to the inner side of the sliding part 35b by a fixing member 37a. The fixing member 37a is attached to a coupling sleeve 51b provided at the actuating piston 5.

Next, the operation of the driver 1a will be described.

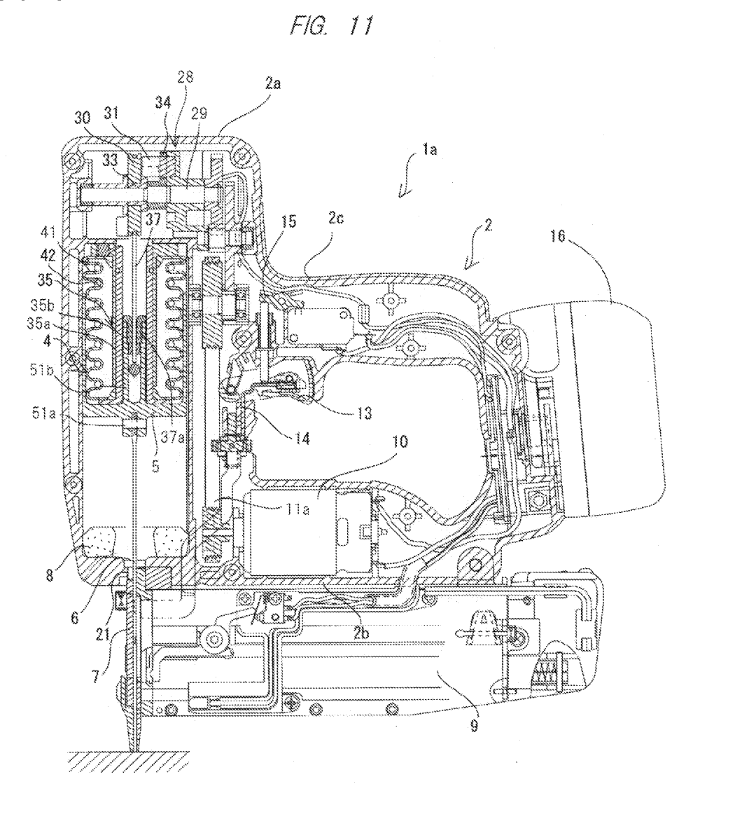

When the trigger 13 of the housing 2 and the push lever 14 are operated in the state shown in FIG. 10 to start the motor 10, the wire 37 is wound up by the wind-up body 30 to shrink the gas pressure accumulation member 4 as shown in FIG. 11. As a result, the actuating piston 5 is moved upward, and the gas in the gas pressure accumulation member 4 is compressed. Then, when a state in which the wire 37 is fed from the wind-up body 30 is obtained, as shown in FIG. 10, the actuating piston 5 is moved downward by the repulsive force of the compressed gas, and the nail is driven by the driver blade 6.

Also in the present embodiment, since the actuating piston 5 is attached to the gas pressure accumulation member 4 so as to be attachable/detachable from the outside, and the driver blade 6 is attached to the actuating piston 5, the replacement of the driver blade 6 can be easily carried out. Also, since the comparatively simple hoisting structure using the wire 37 is used, the driver can be manufactured at low cost, and since the accordion part is not compressed, the durability of the gas pressure accumulation member 4 can be improved. Moreover, since there is no piston sliding part, wear of the sealing part and occurrence of gas leakage can be prevented. Moreover, since the wind-up mechanism 28 is adopted, the gas pressure accumulation member 4 can be compressed with a comparatively long stroke with respect to the structure of the cam or the like.

The wind-up mechanism 28 has a structure in which the wire is wound up by penetrating through the center of the gas pressure accumulation member 4, but similar effects can be obtained also when the wire is wound up by providing latching parts at the piston like the first embodiment. Specifically, as shown in FIG. 16, it is possible to use the cam 12 having the first latching part 12a and the second latching part 12b provided to project from the front surface of the final gear 72 toward the actuating piston 5 side. In that case, the actuating piston 5 can be moved upward by moving the latched part 52b upward by the latching part 12b and moving the latched part 52a upward by the latching part 12a in conjunction with approximately one rotation of the cam 12.

Next, the third embodiment of the present invention will be described.

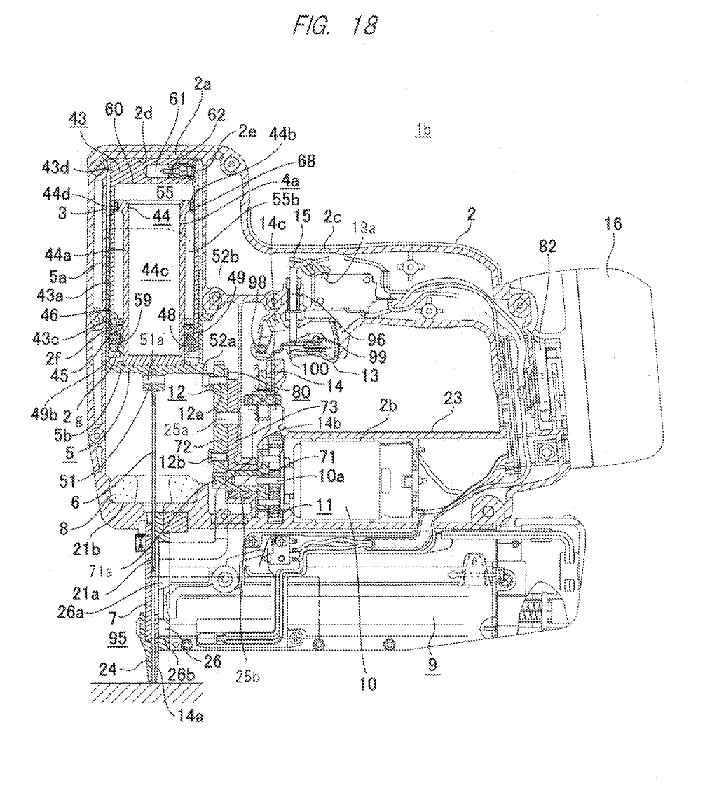

In the drivers 1 and 1a of the first and second embodiments, the gas pressure accumulation member 4 is configured to contain the compressed gas in the bellows 41. However, as shown in FIG. 17 and FIG. 18, in a driver 1b of the third embodiment, a gas pressure accumulation member 4a is made up of a pressure accumulation cylinder 43 in which compressed gas is contained and a pressure accumulation piston 44 which is moved forward/backward in the pressure accumulation cylinder 43.

Since the structure in which the power of the motor 10 is transmitted to the actuating piston 5 by using the deceleration mechanism 11 and the cam 12 is similar to that of the driver 1 of the first embodiment, descriptions thereof will be omitted.

The gas pressure accumulation member 4a has the pressure accumulation cylinder 43 and the pressure accumulation piston 44 which forms a gas pressure accumulation chamber 55 together with the pressure accumulation cylinder 43. The gas pressure accumulation chamber 55 is filled with compressed gas which biases the pressure accumulation piston 44 in a forward direction such as compressed nitrogen gas having a pressure of 0.5 to 10 MPa.

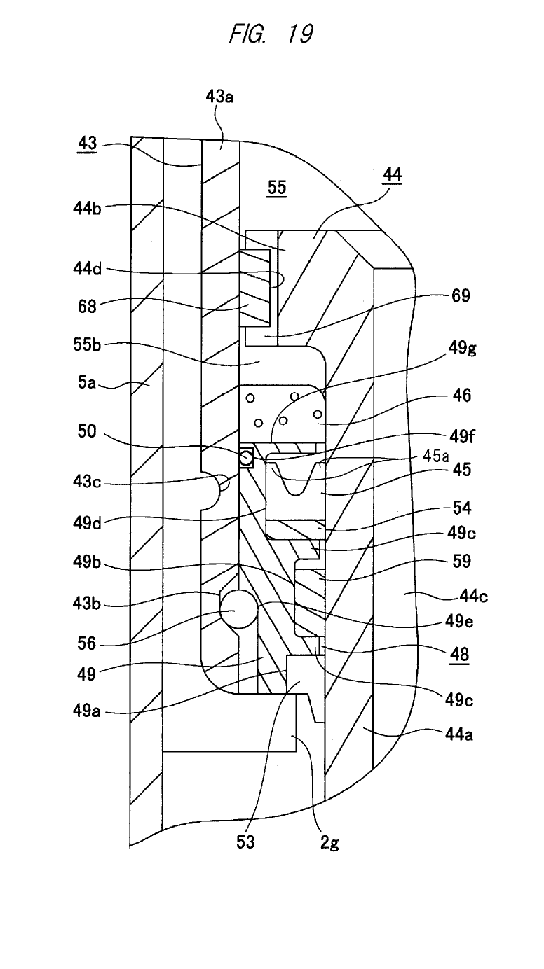

The pressure accumulation cylinder 43 is made up of a tubular body part 43a and a closing wall 60 provided at one end part thereof. The one end part of the tubular body part 43a is closed by the closing wall 60, and a rod through hole 48 is provided at the other end part of the tubular body part 43a. A gas filling port 61 which communicates the gas pressure accumulation chamber 55 of the pressure accumulation cylinder 43 to the outside is provided at a center part of the closing wall 60, and a gas filling valve 62 is attached to the gas filling port 61. As shown in FIG. 19, an annular engaging groove 43b is formed on an inner peripheral part of a lower end part of the pressure accumulation cylinder 43, a stopper ring 56 is attached to the annular engaging groove 43b, and a sleeve 49 is fixed to the pressure accumulation cylinder 43 by the stopper ring 56.

An annular engaging groove 43c is formed on a lower part of the outer peripheral surface of the pressure accumulation cylinder 43, and an annular engaging groove 43d is formed in an upper part thereof. When the gas pressure accumulation member 4a is to be attached to the inside of the housing 2 of the driver 1, a fixing ring part 2e of the housing 2 is engaged with the annular engaging groove 43d, and a fixing ring part 2f is engaged with the annular engaging groove 43c, thereby fixing the gas pressure accumulation member 4a to the housing 2. As another structure, the gas pressure accumulation member may be fixed between a lower end part of the outer periphery of the pressure accumulation cylinder 43 and a ring-like engaging part (illustration omitted) provided on the housing 2.

As shown in FIG. 19, the pressure accumulation piston 44 has a hollow rod part 44a and a flange part 44b integrated with an upper end thereof, and an inner pressure accumulation chamber 44c which forms a part of the gas pressure accumulation chamber 55 is formed in the pressure accumulation piston 44. The pressure accumulation piston 44 is attached so as to be vertically slidable in the rod through hole 48. When the pressure accumulation piston 44 is maximally moved forward by the compressed gas filled in the gas pressure accumulation chamber 55, an annular lower surface of the flange part 44b abuts on a damper 46 which is disposed between an upper surface 49g of the sleeve 49 and the flange part 44b of the pressure accumulation piston 44. In a state in which the pressure accumulation piston 44 is maximally moved backward to the upper side, an annular upper surface of the flange part 44b comes close to the lower surface of the closing wall 60. On the other hand, in a state in which the pressure accumulation piston 44 is maximally moved forward, the lower end part of the pressure accumulation piston 44 projects by an appropriate length from the lower end of the pressure accumulation cylinder 43. The distal end part of the rod part 44a is restricted in the left/right direction by a protrusion 5c provided on the inner surface of the actuating piston 5, the pressure accumulation piston 44 is prevented from being deviated to the left or right with respect to the actuating piston 5 in the striking, and the reduction of the durability and sealability of the sliding part is prevented.

As shown in FIG. 19, a guide-ring attaching groove 44d is formed in the flange part 44b of the pressure accumulation piston 44. A guide ring 68 which contacts the inner surface of the pressure accumulation cylinder 43 is attached to this guide-ring attaching groove 44d. By virtue of this, the slidability of the pressure accumulation piston 44 with respect to the inner surface of the pressure accumulation cylinder 43 is improved. When the pressure accumulation piston 44 is vertically moved, the pressure accumulation piston 44 reciprocates in the axial direction while being guided at two upper and lower locations by the guide ring 68 and the outer peripheral surface of the rod part 44a. Therefore, the pressure accumulation piston 44 is not easily tilted with respect to the pressure accumulation cylinder 43. As shown in FIG. 19, a communication passage 69 is formed in the flange part 44b, and when the pressure accumulation piston 44 is moved upward, the gas pressure accumulation chamber 55 and a gas pressure accumulation chamber 55b outside the rod part 44a can be communicated with each other.

In the gas pressure accumulation chamber 55, the internal space of the pressure accumulation cylinder 43, the inner pressure accumulation chamber 44c of the pressure accumulation piston 44, and the gas pressure accumulation chamber 55b outside the rod part 44a at the time of the upward movement of the pressure accumulation piston 44 are mutually communicated. By virtue of this, when the pressure accumulation piston 44 is moved up to compress the gas pressure accumulation chamber 55, the inner pressure accumulation chamber 44c and the gas pressure accumulation chamber 55b can be effectively utilized as a part of the gas pressure accumulation chamber 55. Therefore, a large volume of the gas pressure accumulation chamber 55 can be ensured although it is compact. Compressed gas such as compressed nitrogen gas is filled in the gas pressure accumulation chamber 55 from a gas supply source such as a nitrogen gas cylinder (not shown) via a gas hose and the gas filling valve 62. The biasing force caused by the compressed gas acts on the pressure accumulation piston 44, and this functions as energy to rapidly move the pressure accumulation piston 44 to the lower side.

Next, the metal-made sleeve 49 which closes the part between the pressure accumulation cylinder 43 and the pressure accumulation piston 44 and forms the rod through hole 48 will be described. As shown in FIG. 19, the sleeve 49 abuts on a flange part 2g of the housing 2 and is fixed to the inner side of an end part of the pressure accumulation cylinder 43. On the inner peripheral side of the sleeve 49, the rod through hole 48 is formed by a U packing 45, a backup ring 54, a guide ring 59, a dust seal 53, and others. On the inner peripheral side of the sleeve 49, a dust-seal attaching groove 49a, a guide-ring attaching groove 49b, ring latching walls 49c, and a U-packing attaching groove 49d are formed. The dust-seal attaching groove 49a is formed on the inner peripheral side of a lower level part of the sleeve 49, and the dust seal 53 made of a hard flexible material is attached to the dust-seal attaching groove 49a. On the inner peripheral side of an intermediate level part, the guide-ring attaching groove 49b is formed by the upper and lower ring latching walls 49c, and the guide ring 59 is attached to the guide-ring attaching groove 49b. Furthermore, the backup ring 54 and the U packing 45 are attached to the U-packing attaching groove 49d.

On the outer peripheral surface of the sleeve 49, an annular engaging part 49e with which the stopper ring 56 is to be engaged is formed in order to fix the sleeve 49 to the pressure accumulation cylinder 43. The stopper ring 56 is attached to the annular engaging groove 43b provided at the distal end part of the pressure accumulation cylinder 43, and the annular engaging part 49e on the sleeve 49 side is engaged with the stopper ring 56 from the upper side, thereby fixing the sleeve 49 to the pressure accumulation cylinder 43 by the stopper ring 56. Furthermore, a seal-member attaching groove 49f is formed in an outer-peripheral upper level part of the sleeve 49, and a seal member 50 made up of, for example, an O ring is attached to the seal-member attaching groove 49f. By virtue of this, the part between the outer surface of the sleeve 49 and the inner surface of the pressure accumulation cylinder 43 is gas-tightly sealed. The flange part 44b of the pressure accumulation piston 44 can be brought into contact with the upper surface 49g of the sleeve 49 via the damper 46.

The flange part 44b abuts on the damper 46 in a case in which the actuating piston 5 is moved downward, the pressure accumulation piston 44 and the actuating piston 5 strongly abut on the piston bumper 8 and are stopped, and the piston bumper 8 is deflected to some degree. On the other hand, usage of the damper 46 becomes unnecessary if a gap is made to be provided between the flange part 44b and the upper surface 49g of the sleeve 49 in the case in which the actuating piston 5 is moved downward, the pressure accumulation piston 44 and the actuating piston 5 strongly abut on the piston bumper 8 and are stopped, and the piston bumper 8 is deflected to some degree.

The dust seal 53 attached to the dust-seal attaching groove 49a is made of a hard material such as urethane resin or NBR. This dust seal 53 removes dust and others adhered onto the outer peripheral surface of the rod part 44a of the pressure accumulation piston 44 and prevents dust and others from entering from a sliding gap between the rod part 44a and the rod through hole 48.

The U packing 45 is made of a rubber material which is more flexible than the guide ring 59 made of synthetic resin, is attached to the U-packing attaching groove 49d, and gas-tightly seals the part between the sleeve 49 and the outer peripheral surface of the rod part 44a of the pressure accumulation piston 44. Lip-like parts 45a are provided at the parts of the upper end surface of the U packing 45 on which the gas pressure act, and when the gas pressure of the compressed gas acts thereon, the lip-like parts 45a are expanded and gas-tightly seal the part between the rod part 44a and the sleeve 49.

The backup ring 54 is made of a synthetic resin material harder than the U packing 45 and forms a ring-like washer shape. The backup ring 54 has a thickness approximately equal to the radial-direction thickness of the U packing 45 and abuts on the surface of the U packing 45 that is on the opposite side of the surface on which the gas pressure acts. In order to prevent the U packing 45 from being displaced to the lower side due to a high pressure, the backup ring 54 receives the U packing 45, which receives the gas pressure, on the back side. In order to improve the slidability of the pressure accumulation cylinder 43 and the pressure accumulation piston 44, the sleeve-like guide ring 59, which is made of synthetic resin, attached to the rod through hole 48 and guides the rod part 44a of the pressure accumulation piston 44, is attached to the guide-ring attaching groove 49b of the sleeve 49. The guide ring 59 has a shape of an integral ring or partially-cut ring, and a gap capable of accepting a volume increase caused by thermal expansion of a thick-plate part of the guide ring 59 made of synthetic resin is provided between the guide ring 59 and the guide-ring attaching groove 49b and the rod part 44a.

Both of the upper and lower ring latching walls 49c for forming the guide-ring attaching groove 49b are formed so as not to contact the outer peripheral surface of the rod part 44a of the pressure accumulation piston 44. The diameter of the inner peripheral surface of the ring latching walls 49c is set to be larger than the outer diameter of the rod part 44a of the pressure accumulation piston 44 by a predetermined length (for example, about 0.2 to 0.5 mm).

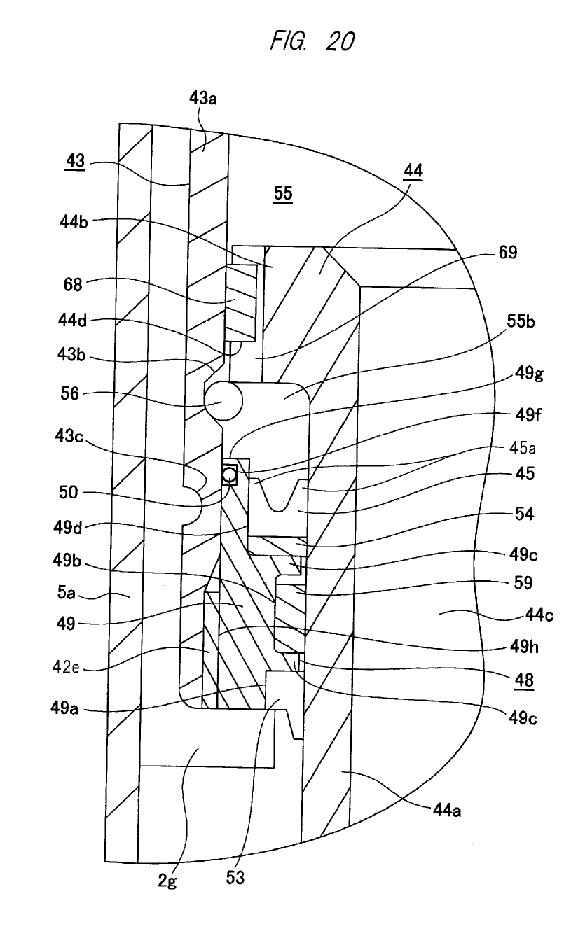

In a modification example shown in FIG. 20, when the sleeve 49 is to be fixed to the pressure accumulation cylinder 43, a screw part 42e and a screw part 49h are formed respectively on the inner peripheral surface of the lower end part of the pressure accumulation cylinder 43 and the outer peripheral surface of the sleeve 49 instead of the stopper ring 56. By virtue of this, the sleeve 49 is screw-coupled to the pressure accumulation cylinder 43.

The actuating piston 5 is made up of a bottomed tubular body having an approximately U-shape cross section, and the driver blade 6 for driving nails is attached to the attachment part 51 provided to project toward the lower side. Since the driver blade 6 is guided by the injection port 21a made up of the driver guide 7, the blade guide 26, and the nose 24, the vertical movement of the actuating piston 5 is guided by the driver blade 6. The actuating piston 5 is always biased downward by the gas pressure accumulation member 4. The end wall part 5b is detachably fixed to the gas pressure accumulation member 4 so as to cover the lower end part of the gas pressure accumulation member 4. In other words, the actuating piston 5 is attached to the gas pressure accumulation member 4 so as to be attachable/detachable from outside. On the lateral surface of the actuating piston 5, the latched parts 52a and 52b are provided to be arranged in the vertical direction. The attachment part 51 is provided on the lower end surface of the actuating piston 5 so as to project therefrom. Also, the cylindrical part 5a extending toward the upper side like a tube is in slidable contact with the tubular guide part 3 of the housing 2 and prevents the actuating piston 5 from being tilted with respect to the housing 2 when sliding vertically. Although not shown in the drawings, it is also possible to improve slidability and wear resistance by providing a tubular thin steel plate between the tubular guide part 3 and the cylindrical part 5a. In the embodiments, the actuating piston 5 is coupled to the driver blade 6 for driving nails, but similar effects can be achieved also when the attachment part 51 is directly provided at the lower part of the pressure accumulation piston 44, the driver blade 6 is attached to the pressure accumulation piston 44, and the driver blade 6 is replaced by detaching it from the pressure accumulation piston 44.

Next, the operation of the driver 1b will be described.

When the trigger 13 of the housing 2 and the push lever 14 are operated in the state shown in FIG. 17 to start the motor 10, the cam 12 moves the actuating piston 5 upward. As a result, as shown in FIG. 18, the pressure accumulation piston 44 is moved upward, and the gas in the pressure accumulation cylinder 43 is compressed.

In the gas pressure accumulation member 4a, the backup ring 54 has the width equal to the radial-direction thickness of the U packing 45 and abuts on the opposite-side surface that is on the opposite side of the gas-pressure acting surface of the U packing 45 to back up it. Therefore, even when the gas pressure of the compressed gas acts on the gas-pressure acting surface of the U packing 45, the opposite-side surface of the U packing 45 is received and backed up by the backup ring 54. Thus, the U packing 45 is prevented from entering the gap between the guide ring 59 and the sleeve 49 and being damaged. Even if a part of the U packing 45 enters the gap between the backup ring 54 and the rod part 44a, adverse effects on the U packing 45 are scarcely generated because the thickness of the backup ring 54 in the shaft center direction is small and the entered length is small. Since the guide ring 59 is integrally formed without having a cut part, the U packing 45 is prevented from entering the guide ring 59 and being damaged.

Moreover, the ring latching walls 49c are formed so as not to be brought into metal-contact with the surface of the rod part 44a of the pressure accumulation piston 44. The guide-ring attaching groove 49b of the guide ring 59 is extended to the opposite side of the U packing 45 with respect to the backup ring 54. Moreover, the guide ring 59 is mated with the outer side of the rod part 44a. Therefore, the rod part 44a of the pressure accumulation piston 44 is guided by the guide ring 59 made of synthetic resin.

In this manner, when the pressure accumulation piston 44 is vertically moved while being guided by the rod through hole 48, the U packing 45 made of synthetic resin, the guide ring 59, the dust seal 53 and others are only brought into contact with the outer peripheral surface of the rod part 44a. Therefore, plating coating of the surface of the rod part 44a is not damaged. Accordingly, the durability of the U packing 45 is improved, and the durability of the guide ring 59 is improved. Moreover, since the backup ring 54 and the U packing 45 are integrally formed to omit a conventional backup ring, the number of parts assembled with the sleeve 49 can be reduced, downsizing at least in the shaft-center direction is achieved, and the manufacturing cost can be reduced.

Then, when the upward movement of the actuating piston 5 by the cam 12 is released, as shown in FIG. 17, the actuating piston 5 is moved downward by the repulsive force of the compressed gas, and the nail is driven by the driver blade 6.

Also in the present embodiment, since the actuating piston 5 is fixed to the gas pressure accumulation member 4a so as to be attachable/detachable from outside and the driver blade 6 is fixed to the actuating piston 5, the replacement of the driver blade 6 can be easily carried out.

The shapes of the actuating piston 5 and the gas pressure accumulation members 4 and 4a are arbitrary and are not limited to those shown in the above-described embodiments. For example, the gas pressure accumulation member 4 is not required to be formed into an accordion-like shape. Also, an intermediate ring coil spring is not required to be wound around the small-diameter part of the accordion-like shape of the gas pressure accumulation member 4. Moreover, the configuration of actuation mechanism is also arbitrary and is not limited to those in the above-described embodiments. Further, the method of fixing the driver blade 6 to the actuating piston 5 is arbitrary and is not limited to those in the above-described embodiments. The embodiment adopts the structure in which the gas pressure accumulation member is compressed by moving the actuating piston, but it is also possible to adopt the structure in which the gas pressure accumulation member is compressed by actuating the driver blade 6 itself by the cam 12 to move the actuating piston 5 instead of just moving the actuating piston.

Moreover, the structure in which the flange part 44b of the pressure accumulation piston 44 is received by the damper 46 is adopted, but effects similar to those described above can be achieved also when the stopper of the pressure accumulation piston 44 in the driving directly receives the rod part 44a by a damper (not shown) and a gap is provided between the pressure accumulation piston 44 and the damper 46.

Next, modification examples in which the above-described embodiments are partially changed will be described. The illustrated sizes, shapes, strokes, and others of the driver body and the pistons of the driver in the first to third embodiments are only examples and can be arbitrarily changed. Other than those, the person skilled in the art can implement the modes in which various modifications are made in the above-described embodiments without departing from the gist of the present invention.

### INDUSTRIAL APPLICABILITY

This driver is applied for driving fasteners such as nails or staples into a driving object material such as a timber.

1-9. (canceled)

10. A driver comprising:
a gas pressure accumulation member;
actuation mechanism which compresses the gas pressure accumulation member and then releases the compression; and
a driver blade disposed to outside of the gas pressure accumulation member and striking a fastener in conjunction with the release of the compression of the gas pressure accumulation member, the driver blade being detachable from the gas pressure accumulation member.

11. The driver according to claim 10, wherein
the gas pressure accumulation member is formed by filling compressed gas in a bellows, and
the driver blade is attached to an actuating piston which is detachably disposed on the gas pressure accumulation member.

12. The driver according to claim 11, wherein
the actuation mechanism includes:
at least a latched part provided on the actuating piston;
a rotor rotated by a power of a motor; and
at least a latching part provided on the rotor.

13. The driver according to claim 10, wherein
the actuation mechanism includes:
an inner piston which penetrates through the gas pressure accumulation member and is configured to be expansible/shrinkable together with the gas pressure accumulation member in a direction of the penetration;
a wire which is fixed to a movable part of the inner piston;
a wind-up body which winds up the wire;
a wind-up mechanism which rotates the wind-up body by a power of a motor; and
shut-off means which shuts off transmission of the power of the motor by the wind-up mechanism.

14. The driver according to claim 10, wherein
the gas pressure accumulation member is formed of an accordion-like bellows having elasticity.

15. The driver according to claim 14, wherein
the gas pressure accumulation member has an intermediate ring wound around a small-diameter part of the accordion-like bellows.

16. The driver according to claim 10, wherein
the gas pressure accumulation member is made up of a pressure accumulation cylinder which contains compressed gas and a pressure accumulation piston which is moved forward/backward in the pressure accumulation cylinder, and
the driver blade is fixed to an actuating piston detachably attached to a distal end surface of the pressure accumulation piston.

17. The driver according to claim 16, wherein
the pressure accumulation piston is a bottomed tubular body having an approximately U shape cross section.

18. The driver according to claim 11, wherein
the driver blade has a base end part mated in a mating hole formed in the actuating piston, and
the driver blade is attached to the actuating piston by mating a pin in a through hole penetrating through the actuating piston and the base end part.
